(19) United States
(12) Patent Application Publication
(10) Pub. No.: US 2016/0188072 A1
(43) Pub. Date: Jun. 30, 2016

(54) TOUCH DISPLAY PANEL

(71) Applicant: SHENZHEN CHINA STAR OPTOELECTRONICS TECHNOLOGY CO., LTD., Shenzhen, Guangdong (CN)

(72) Inventors: Jianxing Xie, Shenzhen, Guangdong (CN); Yao-Li Huang, Shenzhen, Guangdong (CN)

(21) Appl. No.: 14/417,732

(22) PCT Filed: Jan. 5, 2015
(86) PCT No.: PCT/CN2015/070083

§ 371 Date: Jan. 27, 2015

(30) Foreign Application Priority Data
Dec. 29, 2014 (CN) 201410841280.9

(51) Int. Cl. G06F 3/041

(52) U.S. Cl. CPC G06F 3/0416; G06F 2203/04103

(57) ABSTRACT

A touch display panel is provided herein, which comprises an array substrate, a color filter substrate, and a liquid crystal layer. A touch driving electrode is disposed on the array substrate. A first polarizer is disposed at an outer side of the array substrate. A second polarizer is disposed at an outer side of the color filter substrate. The second polarizer has a touch sensing electrode manufactured on an outer surface thereof. In the present invention, the touch sensing electrode is disposed on the polarizer or the cover plate, thereby avoiding fragmentation of the substrates and further improving the product yield rate of the touch display panel.

### BACKGROUND OF THE INVENTION

1. Field of the Invention

The present invention relates to a touch control technology, and more particularly, to a touch display panel.

2. Description of Prior Art

As sharp market competition in smartphones is serious day by day, structure design on a compact product becomes nowadays an important aspect concerned by phone manufactures. In the mainstream of smartphones integrating display and touch functions, display panel manufactures put efforts on studying and developing compact product schemes in order to reduce the extra thickness of touch panel. Currently, On-cell, Hybrid in-cell, and Full-in-cell techniques are developed.

Although the Full-in-cell technique can carry out a compact product by embedding touch control sensors into a liquid crystal display panel, there have inner noise interference and product yield rate issues.

The On-cell and Hybrid in-cell techniques can arrange the touch control sensors on a color filter substrate or an array substrate of the liquid crystal display panel. However, disposing the touch control sensors on the color filter substrate adhering to the array substrate will increase fragmentation rate of the substrates, and thus lead to a lower yield rate for touch display panels.

Therefore, it is necessary to provide a touch display panel for solving the problems existed in the convention skills.

### SUMMARY OF THE INVENTION

The objective of the present invention is to provide a touch display panel having a high production yield rate and a low fragmentation rate, for solving the problem of high fragmentation rate of the substrates and low production yield rate existing in the conventional touch display panels.

To solve above problems, the technical schemes of the present invention are provided below.

The embodiments of the present invention provide a touch display panel, comprising an array substrate, a color filter substrate, and a liquid crystal layer disposed between the array substrate and the color filter substrate, wherein the touch display panel further comprises: a touch driving electrode disposed on the array substrate; a first polarizer disposed at an outer side of the array substrate; a second polarizer disposed at an outer side of the color filter substrate, the second polarizer having a touch sensing electrode manufactured on an outer surface thereof; and a cover plate disposed at an outer side of the second polarizer; wherein the touch display panel further comprises a driving chip, the driving chip provides a common voltage signal for the touch driving electrode when the touch display panel is in a display mode, and the driving chip provides a driving signal for the touch driving electrode when the touch display panel is in a touch control model; wherein the array substrate has a transparent electrode layer manufactured on an inner surface thereof, and the touch driving electrode is formed by pattering the transparent electrode layer.

In the touch display panel of the present invention, the touch sensing electrode is printed on the outer surface of the second polarizer.

In the touch display panel of the present invention, the second polarizer has a transparent electrode layer manufactured on the outer surface thereof, and the touch sensing electrode is formed by pattering the transparent electrode layer.

In the touch display panel of the present invention, the cover plate is disposed at the outer side of the second polarizer through a first adhering layer.

In the touch display panel of the present invention, the second polarizer is disposed at the outer side of the color filter substrate through a second adhering layer.

The embodiments of the present invention provide a touch display panel, comprising an array substrate, a color filter substrate, and a liquid crystal layer disposed between the array substrate and the color filter substrate, wherein the touch display panel further comprises: a touch driving electrode disposed on the array substrate; a first polarizer disposed at an outer side of the array substrate; a second polarizer disposed at an outer side of the color filter substrate, the second polarizer having a touch sensing electrode manufactured on an outer surface thereof; and a cover plate disposed at an outer side of the second polarizer;

In the touch display panel of the present invention, the touch sensing electrode is printed on the outer surface of the second polarizer.

In the touch display panel of the present invention, the second polarizer has a transparent electrode layer manufactured on the outer surface thereof, and the touch sensing electrode is formed by pattering the transparent electrode layer.

In the touch display panel of the present invention, the array substrate has a transparent electrode layer manufactured on an inner surface thereof, and the touch driving electrode is formed by pattering the transparent electrode layer.

In the touch display panel of the present invention, the touch display panel further comprises a driving chip, the driving chip provides a common voltage signal for the touch driving electrode when the touch display panel is in a display mode, and the driving chip provides a driving signal for the touch driving electrode when the touch display panel is in a touch control model.

In the touch display panel of the present invention, the cover plate is disposed at the outer side of the second polarizer through a first adhering layer.

In the touch display panel of the present invention, the second polarizer is disposed at the outer side of the color filter substrate through a second adhering layer.

The embodiments of the present invention provide a touch display panel, comprising an array substrate, a color filter substrate, and a liquid crystal layer disposed between the array substrate and the color filter substrate, wherein the touch display panel further comprises: a touch driving electrode disposed on the array substrate; a first polarizer disposed at an outer side of the array substrate; a second polarizer disposed at an outer side of the color filter substrate; and a cover plate disposed at an outer side of the second polarizer, the cover plate having a touch sensing electrode manufactured on an inner surface thereof.

In the touch display panel of the present invention, the touch sensing electrode is printed on the inner surface of the cover plate.

In the touch display panel of the present invention, the cover plate has a transparent electrode layer manufactured on the inner surface thereof, and the touch sensing electrode is formed by pattering the transparent electrode layer.

In the touch display panel of the present invention, the array substrate has a transparent electrode layer manufactured on an inner surface thereof, and the touch driving electrode is formed by pattering the transparent electrode layer.

In the touch display panel of the present invention, the touch display panel further comprises a driving chip, the driving chip provides a common voltage signal for the touch driving electrode when the touch display panel is in a display mode, and the driving chip provides a driving signal for the touch driving electrode when the touch display panel is in a touch control model.

In the touch display panel of the present invention, the cover plate is disposed at the outer side of the second polarizer through a first adhering layer.

In the touch display panel of the present invention, the second polarizer is disposed at the outer side of the color filter substrate through a second adhering layer.

Compared to the conventional touch display panels, the touch display panel of the present invention arranges the touch sensing electrode on the polarizer or the cover plate, thereby avoiding fragmentation of the substrates and further improving the product yield rate of the touch display panel. The present invention solves the problem of high fragmentation rate of the substrates and low production yield rate existing in the conventional touch display panels.

To make above content of the present invention more easily understood, it will be described in details by using preferred embodiments in conjunction with the appending drawings.

### BRIEF DESCRIPTION OF THE DRAWINGS

FIG. 1 is schematic structural diagram showing a touch display panel in accordance with a first preferred embodiment of the present invention.

FIG. 2 is schematic structural diagram showing a touch display panel in accordance with a second preferred embodiment of the present invention.

### DETAILED DESCRIPTION OF THE PREFERRED EMBODIMENTS

The following descriptions for the respective embodiments are specific embodiments capable of being implemented for illustrations of the present invention with referring to the appended drawings. In the descriptions of the present invention, spatially relative terms, such as “upper”, “lower”, “front”, “back”, “left”, “right”, “inner”, “outer”, “lateral”, and the like, may be used herein for ease of description as illustrated in the drawings. Therefore, it will be understood that the spatially relative terms are intended to illustrate for understanding the present invention, but not to limit the present invention.

In the drawings, units with similar structures are represented by the same reference numbers.

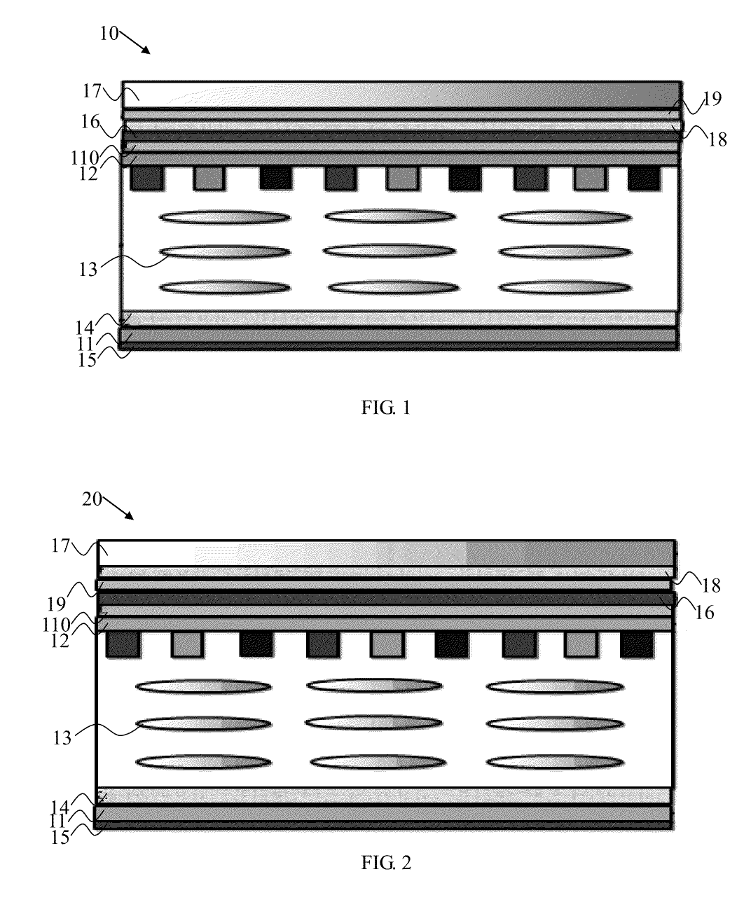

Please refer to FIG. 1, which is schematic structural diagram showing a touch display panel in accordance with a first preferred embodiment of the present invention. The touch display panel 10 of the present preferred embodiment comprises an array substrate 11, a color filter substrate 12, a liquid crystal layer 13 disposed between the array substrate 11 and the color filter substrate 12, and a driving chip (not shown). The touch display panel 10 further comprises a touch driving electrode 14, a first polarizer 15, a second polarizer 16, and a cover plate 17. The touch driving electrode 14 is disposed on the array substrate 11. The first polarizer 15 is disposed at an outer side of the array substrate 11. The second polarizer 16 is disposed at an outer side of the color filter substrate 12. The second polarizer 16 has a touch sensing electrode 18 manufactured on an outer surface thereof. The cover plate 17 is disposed at an outer side of the second polarizer 16. Specifically, the cover plate 17 can be disposed at the outer side of the second polarizer 16 through a first adhering layer 19. The second polarizer 16 can be disposed at the outer side of the color filter substrate 12 through a second adhering layer 110.

The touch sensing electrode 18 (e.g., a transparent electrode) can be manufactured on the outer surface of the second polarizer 16 by using a printing approach. A pattering approach may also be adopted to manufacture the touch sensing electrode 18 on the outer surface of the second polarizer 16. Specifically, a transparent electrode layer is manufactured on the outer surface of the second polarizer 16 and then the transparent electrode layer is patterned by using a photomask whereby the touch sensing electrode 18 is formed.

The touch driving electrode 14 is manufactured on an inner surface of the array substrate 11 by adopting the pattering approach herein. Specifically, a transparent electrode layer is manufactured on the inner surface of the array substrate 11 and then the transparent electrode layer is patterned by using a photomask whereby the touch driving electrode 14 is formed.

In the touch display panel 10 of the present preferred embodiment, when the touch display panel 10 is in a touch control model, the driving chip provides a driving signal for the touch driving electrode 14 such that the touch sensing electrode 18 on the second polarizer 16 can properly sense a user's touch operation occurred on an outer surface of the cover plate 17. When the touch display panel 10 is in a display mode, the driving chip provides a common voltage signal for the touch driving electrode 14 such that the touch driving electrode 14 can serve as a common electrode of the touch display panel 10.

The touch display panel 10 of the present preferred embodiment is manufactured with the touch sensing electrode 18 on the outer surface of the second polarizer 16, rather than manufactured with the touch sensing electrode 18 directly on the outer side of the color filter substrate 12 adhering to the array substrate 11. Accordingly, the fragmentation rate can be lowered well for the adhered substrates, thereby improving the product yield rate of the touch display panel 10.

Meanwhile, adopting the transparent electrode to manufacture the touch sensing electrode 18 and the touch driving electrode 14 can make the touch control display 10 much thinner and lighter, and simplifies the manufacturing process. In addition, a touch control signal is easier to be detected on the touch sensing electrode 14 manufactured on the outer surface of the second polarizer 16 since it is closer to a user's finger.

Please refer to FIG. 2, which is schematic structural diagram showing a touch display panel in accordance with a second preferred embodiment of the present invention. The touch display panel 20 of the present preferred embodiment comprises an array substrate 11, a color filter substrate 12, a liquid crystal layer 13 disposed between the array substrate 11 and the color filter substrate 12, and a driving chip. The touch display panel 20 further comprises a touch driving electrode 14, a first polarizer 15, a second polarizer 16, and a cover plate 17. The touch driving electrode 14 is disposed on the array substrate 11. The first polarizer 15 is disposed at an outer side of the array substrate 11. The second polarizer 16 is disposed at an outer side of the color filter substrate 12. The cover plate 17 is disposed at an outer side of the second polarizer 16. The cover plate 17 has a touch sensing electrode 18 manufactured on an inner surface thereof. Specifically, the cover plate 17 can be disposed at the outer side of the second polarizer 16 through a first adhering layer 19. The second polarizer 16 can be disposed at the outer side of the color filter substrate 12 through a second adhering layer 110.

The touch sensing electrode 18 (e.g., a transparent electrode) can be manufactured on the inner surface of the cover plate 17 by using a printing approach herein. A pattering approach may also be adopted to manufacture the touch sensing electrode 18 on the inner surface of the cover plate 17. Specifically, a transparent electrode layer is manufactured on the inner surface of the cover plate 17 and then the transparent electrode layer is patterned by using a photomask whereby the touch sensing electrode 18 is formed.

The touch driving electrode 14 is manufactured on an inner surface of the array substrate 11 by adopting the pattering approach herein. Specifically, a transparent electrode layer is manufactured on the inner surface of the array substrate 11 and then the transparent electrode layer is patterned by using a photomask whereby the touch driving electrode 14 is formed.

In the touch display panel 20 of the present preferred embodiment, when the touch display panel 20 is in a touch control model, the driving chip provides a driving signal for the touch driving electrode 14 such that the touch sensing electrode 18 on the cover plate 17 can properly sense a user's touch operation occurred on an outer surface of the cover plate 17. When the touch display panel 20 is in a display mode, the driving chip provides a common voltage signal for the touch driving electrode 14 such that the touch driving electrode 14 can serve as a common electrode of the touch display panel 20.

The touch display panel 20 of the present preferred embodiment is manufactured with the touch sensing electrode 18 on the inner surface of the cover plate 17, rather than manufactured with the touch sensing electrode 18 directly on the outer side of the color filter substrate 12 adhering to the array substrate 11. Accordingly, the fragmentation rate can be lowered well for the adhered substrates, thereby improving the product yield rate of the touch display panel 20.

Meanwhile, adopting the transparent electrode to manufacture the touch sensing electrode 18 and the touch driving electrode 14 can make the touch control display 20 much thinner and lighter, and simplifies the manufacturing process. In addition, a touch control signal is easier to be detected on the touch sensing electrode 14 manufactured on the inner surface of the cover plate 17 since it is closer to a user's finger.

In the touch display panel of the present invention, the touch sensing electrode is disposed on the polarizer or the cover plate, thereby avoiding fragmentation of the substrates and further improving the product yield rate of the touch display panel. The present invention solves the problem of high fragmentation rate of the substrates and low production yield rate existing in the conventional touch display panels.

Although the present invention has been illustrated by the preferred embodiments described above, it should be understood for the ordinary skilled person in the art that the present invention is not limited to the embodiments, but rather various changes or modifications thereof are possible without departing from the spirit of the invention. Accordingly, the scope of the invention shall be determined by the appended claims.

What is claimed is:

1. A touch display panel, comprising an array substrate, a color filter substrate, and a liquid crystal layer disposed between the array substrate and the color filter substrate, wherein the touch display panel further comprises:
a touch driving electrode disposed on the array substrate;
a first polarizer disposed at an outer side of the array substrate;
a second polarizer disposed at an outer side of the color filter substrate, the second polarizer having a touch sensing electrode manufactured on an outer surface thereof; and
a cover plate disposed at an outer side of the second polarizer;
wherein the touch display panel further comprises a driving chip, the driving chip provides a common voltage signal for the touch driving electrode when the touch display panel is in a display mode, and the driving chip provides a driving signal for the touch driving electrode when the touch display panel is in a touch control model;
wherein the array substrate has a transparent electrode layer manufactured on an inner surface thereof, and the touch driving electrode is formed by pattering the transparent electrode layer.

2. The touch display panel according to claim 1, wherein the touch sensing electrode is printed on the outer surface of the second polarizer.

3. The touch display panel according to claim 1, wherein the second polarizer has a transparent electrode layer manufactured on the outer surface thereof, and the touch sensing electrode is formed by pattering the transparent electrode layer.

4. The touch display panel according to claim 1, wherein the cover plate is disposed at the outer side of the second polarizer through a first adhering layer.

5. The touch display panel according to claim 1, wherein the second polarizer is disposed at the outer side of the color filter substrate through a second adhering layer.

6. A touch display panel, comprising an array substrate, a color filter substrate, and a liquid crystal layer disposed between the array substrate and the color filter substrate, wherein the touch display panel further comprises:
a touch driving electrode disposed on the array substrate;
a first polarizer disposed at an outer side of the array substrate;
a second polarizer disposed at an outer side of the color filter substrate, the second polarizer having a touch sensing electrode manufactured on an outer surface thereof; and
a cover plate disposed at an outer side of the second polarizer;

7. The touch display panel according to claim 6, wherein the touch sensing electrode is printed on the outer surface of the second polarizer.

8. The touch display panel according to claim 6, wherein the second polarizer has a transparent electrode layer manufactured on the outer surface thereof, and the touch sensing electrode is formed by pattering the transparent electrode layer.

9. The touch display panel according to claim 6, wherein the array substrate has a transparent electrode layer manufactured on an inner surface thereof, and the touch driving electrode is formed by pattering the transparent electrode layer.

10. The touch display panel according to claim 6, wherein the touch display panel further comprises a driving chip, the driving chip provides a common voltage signal for the touch driving electrode when the touch display panel is in a display mode, and the driving chip provides a driving signal for the touch driving electrode when the touch display panel is in a touch control model.

11. The touch display panel according to claim 6, wherein the cover plate is disposed at the outer side of the second polarizer through a first adhering layer.

12. The touch display panel according to claim 6, wherein the second polarizer is disposed at the outer side of the color filter substrate through a second adhering layer.

13. A touch display panel, comprising an array substrate, a color filter substrate, and a liquid crystal layer disposed between the array substrate and the color filter substrate, wherein the touch display panel further comprises:
a touch driving electrode disposed on the array substrate;
a first polarizer disposed at an outer side of the array substrate;
a second polarizer disposed at an outer side of the color filter substrate; and
a cover plate disposed at an outer side of the second polarizer, the cover plate having a touch sensing electrode manufactured on an inner surface thereof.

14. The touch display panel according to claim 13, wherein the touch sensing electrode is printed on the inner surface of the cover plate.

15. The touch display panel according to claim 13, wherein the cover plate has a transparent electrode layer manufactured on the inner surface thereof, and the touch sensing electrode is formed by pattering the transparent electrode layer.

16. The touch display panel according to claim 13, wherein the array substrate has a transparent electrode layer manufactured on an inner surface thereof, and the touch driving electrode is formed by pattering the transparent electrode layer.

17. The touch display panel according to claim 13, wherein the touch display panel further comprises a driving chip, the driving chip provides a common voltage signal for the touch driving electrode when the touch display panel is in a display mode, and the driving chip provides a driving signal for the touch driving electrode when the touch display panel is in a touch control model.

18. The touch display panel according to claim 13, wherein the cover plate is disposed at the outer side of the second polarizer through a first adhering layer.

19. The touch display panel according to claim 13, wherein the second polarizer is disposed at the outer side of the color filter substrate through a second adhering layer.
